(19) United States
(12) Patent Application Publication
(10) Pub. No.: US 2014/0356479 A1
(43) Pub. Date: Dec. 4, 2014

(54) COMPOSITIONS AND METHODS FOR USE IN PROMOTING LEAN BODY MASS

(71) Applicant: Eric Serrano, Pataskala, OH (US)

(72) Inventor: Eric Serrano, Pataskala, OH (US)

(73) Assignee: MUSCLEPHARM CORPORATION, Denver, CO (US)

(21) Appl. No.: 14/239,323

(22) PCT Filed: Aug. 17, 2012
(86) PCT No.: PCT/US2012/051428

§ 371 Date: Jul. 14, 2014

Related U.S. Application Data
(60) Provisional application No. 61/525,527, filed on Aug. 19, 2011.

(51) Int. Cl. A23L 1/305; A23L 1/30; A23L 1/29; A23L 1/302; A23L 2/52

(52) U.S. Cl. CPC A23L 1/3051; A23L 1/302; A23L 2/52; A23L 1/296; A23L 1/3006; A23V 2002/00
USPC 426/2; 426/656; 426/72; 426/590; 426/573; 426/648

(57) ABSTRACT

Food supplement compositions and their methods of use in promoting lean body mass are provided.

This application is being filed on 17 Aug. 2012, as a PCT International patent application in the name of MusclePharm Corporation, a U.S. national corporation, applicant for the designation of all countries except the US, Eric Serrano, a citizen of the U.S., applicant for the designation of the US only, and claims priority to U.S. Provisional Application Ser. No. 61/525,527 filed Aug. 19, 2011, the subject matter of which is incorporated by reference in its entirety.

### FIELD

This disclosure relates to nutritional products, and in particular, nutritional supplements for improving lean body mass and for mitigating muscle breakdown.

### BACKGROUND

The statements in this section merely provide background information related to the present disclosure and may not constitute prior art.

Hundreds of amino acid supplement products are available on the market. The majority of these products are poorly absorbed in the human gastrointestinal tract due to flaws in the formulas. In some products, the ingredients are of poor quality or the combinations of amino acids are improper. Many products are improperly formulated for efficient gut absorption, for example, tableted products take time to disintegrate. Further, amino acids can be damaged by the stomach pH and the bile acids released upon ingestion of various food types such as fatty foods.

Further effort is needed to identify food compositions which provide an individual with the nutrients needed to increase lean body mass.

The present invention is directed toward overcoming one or more of the problems discussed above.

### SUMMARY

Further areas of applicability of the present teachings will become apparent from the description provided herein. It should be understood that the description and specific examples are intended for purposes of illustration only and are not intended to limit the scope of the present teachings.

Provided herein are food compositions comprising: (a) L-Isoleucine, (b) L- Leucine, (c) L- Valine, wherein the ratio of (a) to (b) to (c) is about 1-1.5:2.5-3.5:1-2.5. In some aspects, the ratio is about 1:3:2.

In some aspects, the composition further comprises one or more amino acids selected from the group consisting of (d) L- Taurine, (e) L-Phenylalanine, (f) L-Methionine, (g) L-Threonine, (h) L-Lysine, (i) L-Glutamine and (j) L-Arginine. In some aspects the compositions herein include the addition of L-Taurine and Glutamine.

In other aspects, the composition further comprises niacin and/or vitamin B6.

Further provided herein are methods of using such compositions. In some embodiments, a method of mitigating muscle deterioration in a subject is provided. The composition can be administered before, during, or after a workout.

In some aspects, the composition is a meal replacement. In other aspects, the composition is a nutritional supplement. In still other aspects, the composition is a drink, a gel, or a nutritional supplement.

### DETAILED DESCRIPTION

The following description is merely exemplary in nature and is not intended to limit the present disclosure, application, claims, compositions, or uses.

Provided herein are edible compositions (food compositions) which can be used independently (as a snack supplement or as a replacement meal) or mixed into various liquids and soft foods to provide improved lean body mass and to mitigate muscle breakdown. The compositions comprise certain amino acids in specific ratios, and can further include additional ingredients typically associated with a supplement.

Amino acids serve as the building blocks of proteins; they link together in specific sequences to form proteins. Twenty-two amino acids are naturally incorporated into polypeptides and are called proteinogenic or standard amino acids. Twenty of these naturally occurring amino acids are encoded by the universal genetic code. Eight standard amino acids are called “essential” for humans because they cannot be synthesized by the human body at the level needed for normal growth and so must be taken in as food.

When consumed by a human, the twenty-two standard amino acids are either used to synthesize proteins and other biomolecules or are oxidized to urea and carbon dioxide as a source of energy. Amino acid oxidation begins with the removal of the amino group by a transaminase, then the amino group is fed into the urea cycle. The remaining keto acid enters the citric acid cycle.

Different amino acid ratios can have different effects when ingested by a subject. Disclosed herein are compositions, conceived of by the inventor, comprising certain amino acids in particular ratios. Surprisingly, these compositions are particularly good at achieving one or more of the following when administered to a human subject: a gain in lean body mass without a gain in adipose tissue; faster gain of lean body mass; highly efficient absorption without regard to the health of the digestive tract; capacity for increased work performance over a given time period; mitigation of muscle breakdown and soreness; improved recovery times; improved muscle strength and stamina; prevention of overtraining and thus prevention of potential injury or burnout; improved and balanced blood hormone levels; mitigation of increase in catabolic hormones; replenish muscle substrates; increase protein synthesis; reduce catabolism; increase immune vitality and energy; and mobilize body fat. Note that “lean body mass” herein refers to the amount of muscle mass of a subject divided by the total body weight of the subject or the amount of muscle without fat.

It is contemplated that the compositions disclosed herein can be used as a meal replacement, as a supplement added to existing food products, or formulated as a stand-alone product such as a gel or candy. It is further contemplated that the compositions disclosed herein can be formulated as a liquid, as a gel, as a powder, or a solid or semi-solid food product. Where the compositions are formulated as a gel, the delivery of the composition to the subject is surprisingly quick and the benefits of the compositions on the subject unexpectedly fast. In some aspects, the composition is mixed with water or other liquid prior to ingestion. In other aspects, the composition is sprinkled on or into an existing product such as a shake or a salad.

The composition can be administered (consumed or ingested) on an as needed basis. This can depend on the dietary needs of the subject, such as the weight and sex of the subject, and the workout intensity level. In some aspects, the composition is administered more than once daily. In some embodiments, such compositions can be ingested prior to a workout, for example, at least about 30 minutes prior, at least about 45 minutes prior, at least about 1 hour prior, or at least about 2 hours prior to a workout. In other embodiments, such compositions can be ingested after a workout, for example, at least about 30 minutes after, at least about 45 minutes after, at least about 1 hour after, or at least about 2 hours after a workout. In still other embodiments, such compositions can be ingested during a workout. In some embodiments, the composition can be a snack for consumption between meals and/or before bed. In still other embodiments, compositions herein can be ingested both before and after a workout, for example, at least about 30 minutes prior, at least about 45 minutes prior, at least about 1 hour prior and at least about 30 minutes after, at least about 45 minutes after and at least about 1 hour after. Consumption can be, for example, 30 minutes before a workout and 45 minutes after a workout or any other combination of the above. Ingestion of the composition embodiments described herein at the time parameters described above, in relation to a workout, provides the subject with less soreness and an increase lean body mass faster than protein drinks or placebo. While not being tied to any particular mechanism, embodiments herein provide the subject with a properly timed flood of proper building blocks for muscle, including timing with the subject's release of hormonal signals that incorporate those building blocks.

Disclosed herein are compositions comprising (a) L-Isoleucine, (b) L-Leucine, and (c) L- Valine, wherein the ratio is about 1-1.5:2.5-3.5:1-2.5. The amino acid ratios provide the body with the right amount of each amino acid before and after workouts for the prevention of muscle breakdown and the accretion of striated muscle. As described herein ratios are calculated on a weight basis.

The compositions further comprise one or more amino acids selected from the group consisting of (d) L- Taurine, (e) L-Phenylalanine, (f) L-Methionine, (g) L-Threonine, (h) L-Lysine, (i) L-Arginine, and (j) L-glutamine. The total amount of amino acids per serving can be from about 2000 mg to about 10,000 mg, for example, about 2000 mg, about 3000 mg, about 4000 mg, about 5000 mg, about 6000 mg, about 7000 mg, about 8000 mg, about 9000 mg, or about 10,000 mg per serving. In some aspects, L-glutamine is present in the composition in an amount of about 3 to 5 grams and L-taurine is present in the composition in an amount of at least about 2 grams. In other embodiments both L-glutamine and L-taurine are present in the composition in an amount of from 2 to 6 grams and more particularly 3 to 6 grams.

In some aspects, the composition consists essentially of (a) L-Isoleucine, (b) L- Leucine, (c) L- Valine, (d) L- Taurine, (e) L-Phenylalanine, (f) L-Methionine, (g) L-Threonine, (h) L-Lysine, (i) L-Arginine, and (j) L-glutamine. The amino acids (a)-(c) are present in the composition in the following ratios: about 1-1.5:2.5-3.5:1-2.5, for example, about 1:3:2 or about 1:3:1 or about 1:2.5:1.5.

In other aspects, the composition consists essentially of (a) L-Isoleucine, (b) L- Leucine, (c) L- Valine, (d) L- Taurine, and (j) L-glutamine. The amino acids (a)-(c) are present in the composition in the following ratios: about 1-1.5:2.5-3.5:1-2.5, for example, about 1:3:2 or about 1:3:1 or about 1:2.5:1.5.

The compositions can further comprise nutrients selected from the group consisting of niacin (for example, about 1 mg to about 200 mg per serving, or about 5 mg, about 10 mg, about 15 mg, about 20 mg, about 30 mg, about 50 mg, about 100 mg, about 120 mg, about 150 mg, or about 200 mg per serving), Vitamin B6 (for example, about 0.5 mg to about 25 mg per serving, or about 0.6 mg, about 0.8 mg, about 1 mg, about 1.2 mg, about 1.4 mg, about 1.6 mg, about 1.8 mg, about 2 mg, about 4 mg, about 5 mg, about 6 mg, about 10 mg, about 12 mg, about 15 mg, about 20 mg per serving), and L Glutamine (about 1000 mg, about 1200 mg, about 1400 mg, about 1600 mg, about 1800 mg, about 2000 mg, about 2200 mg, about 2400 mg, about 2600 mg, about 2800 mg, or about 3000 mg).

In some aspects, the composition consists essentially of (a) L-Isoleucine, (b) L- Leucine, (c) L- Valine, (d) L- Taurine, (e) L-Phenylalanine, (f) L-Methionine, (g) L-Threonine, (h) L-Lysine, and (i) L-Arginine, and further comprises one or more of the following (j) L-Glutamine, (k) Vitamin B6, and (1) niacin. The amino acids (a)-(c) are present in the composition in the following ratios: about 1-1.5:2.5-3.5:1-2.5 or about 1:2.5-3:1-2, for example, about 1:3:2 or about 1:3:1 or about 1:2.5:1.5.

In some embodiments, the composition comprises (a) L-Isoleucine, (b) L- Leucine, and (c) L- Valine. These amino acids are present in the composition in the following ratios: about 1-1.5:2.5-3.5:1-2.5 or about 1:2.5-3:1-2, for example, about 1:3:2 or about 1:3:1 or about 1:2.5:1.5.

In some aspects, the composition consists essentially of (a) L-Isoleucine, (b) L- Leucine, (c) L- Valine, and (d) L- Taurine, and further comprises one or more of the following (j) L-Glutamine, (k) Vitamin B6, and (1) niacin. The amino acids (a)-(c) are present in the composition in the following ratios: about 1-1.5:2.5-3.5:1-2.5 or about 1:2.5-3:1-2, for example, about 1:3:2 or about 1:3:1 or about 1:2.5:1.5.

In some aspects, the compositions further comprise one or more amino acids selected from the group consisting of tryptophan (for example, about 500 mg per serving), threonine (for example, about 500 mg per serving), valine (for example, about 2 g per serving), phenylalanine (for example, about 500 mg per serving), isoleucine (for example, about 2 g to about 3 g per serving), leucine (for example, about 3 g to about 5 g per serving), lysine (for example, about 500 mg per serving), methionine (for example, about 1000 mg per serving), and taurine (for example, about 2 g per serving).

In some embodiments, a combination of the amino acids provided herein is included in the composition in a total amount from about 2 g to about 40 g per serving, or about 10 g to about 20 g per serving, or about 25 to about 40 g per serving, or about 20 g per serving, or about 25 g per serving, or about 30 g per serving, or about 35 g per serving. Total amino acid dosage can be determined based upon the weight of the individual consuming the composition. Illustratively, an individual might consume 0.15 mg of amino acids per kilogram of body weight.

The amino acids are available in free form, and as such, it is possible to provide them in any desired amount or according to any specific ratio.

Compositions disclosed herein can further comprise fat, carbohydrates, and/or protein. In some embodiments, a one serving portion of the composition comprises about 1.0 grams, about 1.2 grams, about 1.3 grams, about 1.4 grams, about 1.5 grams, about 1.6 grams, about 1.7 grams, 1.8 grams, 1.8 grams, or 2.0 grams of fat. In some embodiments, a one serving portion of the composition comprises about 20 grams of amino acids. In some embodiments, a one serving portion of the composition comprises about 1 to about 5 grams of carbohydrates, for example, about 1 gram, about 2 grams, about 3 grams, about 4 grams, or about 5 grams of carbohydrates. In an exemplary embodiment, a one serving portion of the composition provides about 20 grams of amino acids, about 3 grams of carbohydrates, and about 1.5 grams of fat. In some aspects, composition comprises about 15 grams to about 35 grams total.

Compositions described herein can further be combined with herbs, other proteins, such as, for example, whey, casein, and other protein sources, and/or other supplements.

Antioxidants which provide antioxidant potentiating properties in the body may also be included in the composition. Examples of such antioxidants include, but are not limited to, lecithin, lactoperoxidase, and lactoferrin. Typically the concentration of antioxidants ranges from about 0.01% by weight to about 5.0% by weight in the composition, more typically the concentration is in the range of about 0.10% by weight to about 0.15% by weight.

A preservative of the kind known in the food industry may be added to provide freshness. An exemplary preservative is tocopherol (vitamin E). The concentration of preservative ranges from about 0.01% by weight to about 1.0% by weight. In one embodiment the concentration of preservative is in the range of about 0.01% by weight to about 0.015% by weight.

Various flavorings and sweeteners can be added to provide palatability. For example, vanilla flavorings may be present at a concentration ranging from about 1% by weight to about 5% by weight. Sweeteners, including natural sweeteners or artificial sweeteners, can be present at a concentration ranging from about 0.1% by weight to about 1.0% by weight.

One skilled in the art of food and dietary supplements will recognize that there are a number of different flavorings and antioxidants which may be used in combination with the amino acid compositions disclosed herein. In addition, there are a variety of polypeptides and other amino acids which are known to be beneficial to the body and which may be added to the composition as well, for particular remedial health benefits. It is not intended that the scope of the invention be limited to the exemplary compositions described herein.

Further provided are methods for mitigating muscle deterioration in a subject comprising administration to the subject the compositions described herein. Also provided are methods for improving lean body mass in a subject comprising administration to the subject the compositions described herein.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

### EXAMPLES

The following examples are provided for illustrative purposes only and are not limiting to this disclosure in any way.

### Example 1

The formulations and ratios described herein were developed after two years of research that included looking at muscle biopsies and amino acid composition of human muscle, amino acid ratios in food stuffs in a raw protein state, amino acid ratios after degrading or cooking foods containing proteins, and amino acid ratios from post workout blood tests relative to amino acid ratios in the blood before activity.

Thirteen subjects with prior workout history (advanced level athletes) tested the disclosed formulations. The objective measurements were strength (measured by the number of repetitions on bench press and squats), lean body mass (measured using fat calipers), and bodyweight. Eleven of the thirteen subjects had increase in strength and decrease in skin folds after 8 weeks.

### Example 2

New Study Finds Increased of Death in HIV Patients with Muscle Loss and Fat Gain Underscores the need for high quality protein supplementation in people living with HIV

BOSTON, Mar. 22, 2011—Data presented at the 18th Conference on Retroviruses and Opportunistic Infections (CROI) on March 1 demonstrated that reduced muscle mass and increased abdominal fat significantly elevates the risk of death in HIV patients. This study underscores the need for scientifically designed therapeutic nutritional products such as MusclePharm's MuscleGel that have been developed to help build muscle mass and decrease fat.

The Fat Redistribution and Metabolic Change in HIV Infection (FRAM) study enrolled 1,183 HIV positive men and women and assigned them to 3 groups based on arm, leg and waist circumferences. Researchers found that the patients in the lowest arm muscle, lowest leg muscle and highest visceral fat groups were twice as likely as those in the highest arm and leg muscle and lowest visceral fat groups to die in the 5 year follow-up period.

The study shows that despite advances in the treatment of HIV/AIDS, muscle loss is still a major health concern. This condition is often attributed to wasting syndrome (catabolic cachexia), which was once a leading cause of death for people living with AIDS in the U.S.

According to Chief Scientific Director Dr. Roscoe M. Moore Jr., former Assistant United States Surgeon General, “The results of this study are a wake-up call reminding us that steps must be taken to assist people living with HIV to prevent and/or treat the onset of muscle loss. Whey protein is known to build muscle mass, which will help prevent catabolic cachexia. MuscleGel can provide patients with an optimal delivery of protein supplementation to address some of the clinical concerns addressed in the FRAM study.”

Whey protein increases levels of glutathione, a naturally occurring peptide associated with improved immune system function that also protects against oxidative stress. MuscleGel is a flavored, sugar free gel that provides 22 grams of high quality, highly bioavailable whey isolate per serving.

Unfortunately, high quality whey protein supplements are often too costly to be purchased on a regular basis by HIV patients who are living on a fixed income. MusclePharm, the maker of MuscleGel, is currently applying for New York Medicaid reimbursement in order for the product to be available free of cost for people living with HIV who receive Medicaid. MusclePharm plans on seeking Medicaid reimbursement in all states and territories.

“While the current antiretroviral therapies have significantly reduced the number of HIV/AIDS patients experiencing wasting syndrome, there is still a great need for products that can help HIV wasting patients add muscle mass in order to increase their survival outlook,” noted Strategic Advisor James Sapirstein, RPh, MBA.

When introducing elements or features of embodiments herein, the articles “a”, “an”, “the” and “said” are intended to mean that there are one or more of such elements or features. The terms “comprising”, “including”, and “having” are intended to be inclusive and mean that there may be additional elements or features other than those specifically noted. The phrase “consisting essentially of” refers to the specified materials or steps “and those that do not materially affect the basic and novel characteristic(s)” of the claimed subject matter. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A food composition comprising:
(a) L-Isoleucine,
(b) L- Leucine,
(c) L- Valine,
wherein the ratio is about 1-1.5:2.5-3.5:1-2.5.

2. The composition of claim 1, wherein the composition further comprises one or more amino acids selected from the group consisting of
(d) L- Taurine,
(e) L-Phenylalanine,
(f) L-Methionine,
(g) L-Threonine,
(h) L-Lysine, and
(i) L-Arginine.

3. The composition of claim 1, wherein the composition further comprises niacin.

4. The composition of claim 2, wherein the composition further comprises Vitamin B6.

5. The composition of claim 1, wherein the composition further comprises L-Glutamine.

6. The composition of claim 1, wherein the composition further comprises about 1.5 grams of fat.

7. The composition of claim 1, wherein the composition comprises about 28 grams and is administered more than once daily.

8. The composition of claim 1, wherein a one serving portion of the composition provides about 20 grams of amino acids and about 3 grams of carbohydrates.

9. The composition of claim 1, wherein the composition is mixed with a liquid to provide a drink.

10. The composition of claim 1, wherein the composition is formulated as a gel.

11. The composition of claim 1, wherein the composition is formulated as a post-exercise supplement.

12. The composition of claim 1, wherein a one serving portion of the composition provides about 20 grams of amino acids, about 3 grams of carbohydrates, and about 1.5 grams of fat.

13. The composition of claim 1, wherein the composition further comprises antioxidants.

14. The composition of claim 1, wherein the composition further comprises flavorings.

15. The composition of claim 1, wherein the composition further comprises sweeteners.

16. A method of mitigating muscle deterioration in a subject, the method comprising administration to the subject a composition comprising
(a) L-Isoleucine,
(b) L- Leucine, and
(c) L- Valine,
wherein the ratio is about 1:3:2.

17. The method of claim 16, wherein the composition further comprises one or more amino acids selected from the group consisting of
(d) L- Taurine,
(e) L-Phenylalanine,
(f) L-Methionine,
(g) L-Threonine,
(h) L-Lysine, and
(i) L-Arginine,

18. The method of claim 16, wherein the composition is administered before, during, or after a workout.

19. The method of claim 16, wherein the composition is a meal replacement.

20. The method of claim 16, wherein the composition is a nutritional supplement.

21. The method of claim 16, wherein the composition further comprises a nutrient selected from the group consisting of niacin, vitamin B6, and L-glutamine.

22. The method of claim 16, wherein the composition is administered within 30 minutes of a workout and/or within 30 minutes after a workout.
